(19) United States
(12) Patent Application Publication
(10) Pub. No.: US 2025/0278162 A1
(43) Pub. Date: Sep. 4, 2025

(54) INFORMATION PROCESSING APPARATUS, DISPLAY CONTROL METHOD, AND RECORDING MEDIUM

(71) Applicant: CASIO COMPUTER CO., LTD., Tokyo (JP)

(72) Inventor: Riku ISHITSUKA, Tokyo (JP)

(73) Assignee: CASIO COMPUTER CO., LTD., Tokyo (JP)

(21) Appl. No.: 19/066,320

(22) Filed: Feb. 28, 2025

(30) Foreign Application Priority Data
Mar. 1, 2024 (JP) 2024-030873

(51) Int. Cl. G06F 3/0481; G06F 3/0485

(52) U.S. Cl. CPC G06F 3/0481; G06F 3/0485; G06F 2203/04803

(57) ABSTRACT

An information processing apparatus includes a processor, in which, in a case of setting a first display region and a second display region on a display screen on which a display displays designated information, the first display region displaying a first portion of the information in a scrollable state and the second display region displaying a second portion of the information different from the first portion in a non-scrollable state, the processor changes an amount of displayable information in the first display region and an amount of displayable information in the second display region in accordance with a user operation of scrolling display in the first display region.

### CROSS-REFERENCE TO RELATED APPLICATION

This application claims priority based on Japanese Patent Application No. 2024-030873 filed on Mar. 1, 2024, and the entire disclosure including the specification, claims, drawings, and abstract is incorporated herein by reference.

### BACKGROUND

### 1. Technical Field

The present disclosure relates to an information processing apparatus, a display control method, and a recording medium.

### 2. Related Art

In an electronic dictionary, in a case where all the detailed information related to a searched entry word cannot be displayed on a display at a time, a portion of the detailed information to be displayed on the display can be changed by a scroll operation. Some of this type of electronic dictionaries can divide a display screen of the display into upper and lower parts, and scroll one of the upper and lower divided screens in a state where the other of the divided screens kept in a fixed state (for example, JP 2013-186753 A).

### SUMMARY

An information processing apparatus according to an aspect of the present disclosure includes a processor that, in a case of setting a first display region and a second display region on a display screen on which a display displays designated information, the first display region displaying a first portion of the information in a scrollable state and the second display region displaying a second portion of the information different from the first portion in a non-scrollable state, changes an amount of displayable information in the first display region and an amount of displayable information in the second display region in accordance with a user operation of scrolling display in the first display region.

### BRIEF DESCRIPTION OF THE DRAWINGS

FIG. 1 is a diagram illustrating an external configuration example of an electronic dictionary according to an embodiment;

FIG. 2 is a block diagram illustrating a functional configuration example of the electronic dictionary;

FIGS. 3A and 3B are diagrams for explaining an example of a hierarchical structure of dictionary data;

FIGS. 4A and 4B are diagrams for explaining an example of priority information;

FIGS. 5A and 5B are diagrams for explaining a threshold of a fixed display region in a display screen;

FIG. 6 is a flowchart illustrating an example of processing performed by the electronic dictionary;

FIG. 7 is a flowchart illustrating a specific example of fixed display setting processing in FIG. 6;

FIG. 8 is a diagram illustrating an example of a change in a scrollable region in a display screen;

FIGS. 9A to 9C are diagrams for explaining an example of updating display in accordance with a scroll operation; and

FIGS. 10A and 10B illustrate an example of switching display of fixedly displayed information.

### DETAILED DESCRIPTION

Hereinafter, an embodiment of the present disclosure will be described with reference to the drawings.

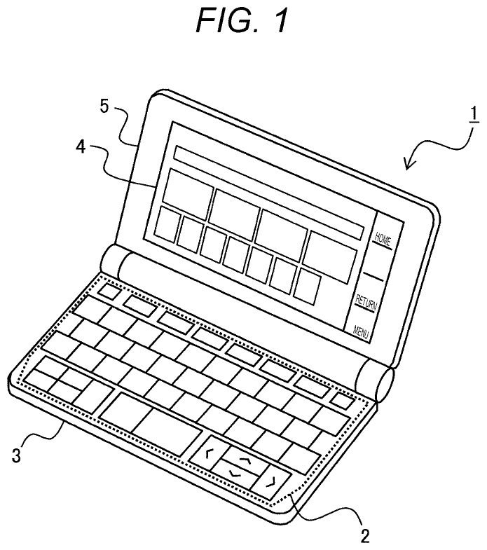

An electronic dictionary 1 illustrated in FIG. 1 includes a first housing portion 3 including a keyboard 2 and a second housing portion 5 including a touch panel display 4. The first housing portion 3 and the second housing portion 5 are coupled to each other by, for example, a hinge mechanism or the like such that an angle of a display surface of the touch panel display 4 in the second housing portion 5 with respect to a surface of the first housing portion 3 on which keys of the keyboard 2 are disposed can be changed. Because the external configuration of the electronic dictionary 1 may be a well-known configuration, a specific description of the external configuration of the electronic dictionary 1 will be omitted in the present specification. Note that the external configuration of the electronic dictionary 1 is not limited to the external configuration illustrated in FIG. 1.

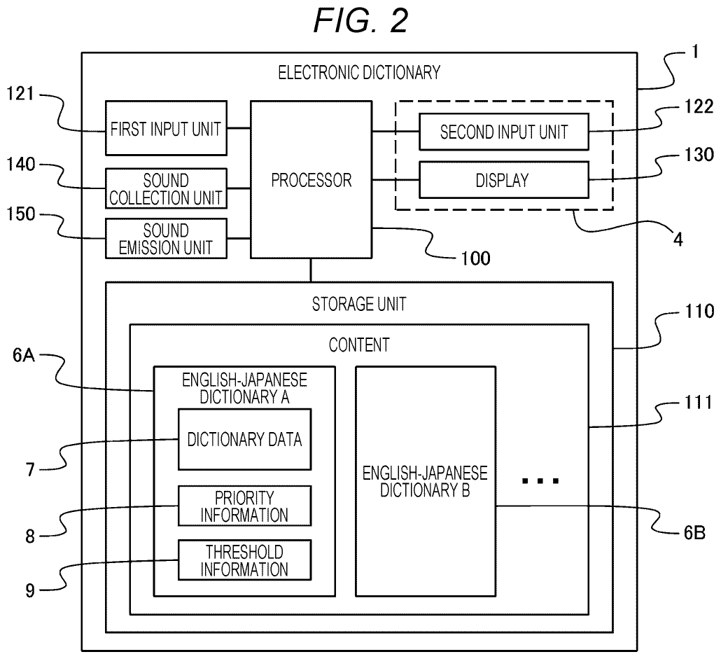

The electronic dictionary 1 is an exemplification of an information processing apparatus according to the present disclosure. The electronic dictionary 1 can be an electronic device specialized in providing a plurality of types of content including dictionary content. As illustrated in FIG. 2, from the viewpoint of the functional configuration, the electronic dictionary 1 includes a processor 100, a storage unit 110, a first input unit 121, a second input unit 122, a display 130, a sound collection unit 140, and a sound emission unit 150. The electronic dictionary 1 may include a function not illustrated in FIG. 2, for example, a communication unit for communicating with an external device.

The processor 100 controls the working of the electronic dictionary 1. For example, the processor 100 executes the content of the dictionary, and performs processing of searching for an entry word input or selected by a user operation and displaying a search result. The functions of the processor 100 are provided by at least one processor that executes an operating system (OS) program, various programs related to the use of content stored (recorded) in the storage unit 110, and the like. The processor can include a central processing unit (CPU).

The storage unit 110 stores content data 111 including a plurality of types of content, and other data, programs, and the like that are not illustrated. The storage device that provides the function of the storage unit 110 includes a read only memory (ROM) and a random access memory (RAM). A part of the functions of the storage unit 110 may be provided by, for example, a cache memory built in a processor such as a CPU, or a portable recording medium such as a card type memory.

The content data 111 can include content 6A of an English-Japanese dictionary A and content 6B of an English-Japanese dictionary B illustrated in FIG. 2, and one or more pieces of content not illustrated in FIG. 2. The contents 6A and 6B of the English-Japanese dictionary are examples of the content of the dictionary. The content of the dictionary may include content different from the English-Japanese dictionary, for example, a Japanese-English dictionary, a Japanese dictionary, a dictionary in which a relationship between a foreign language other than English and Japanese is described, and other character dictionaries and encyclopedias. The content of the dictionary includes, for example, dictionary data 7, priority information 8, and threshold information 9 illustrated in the content 6A of the English-Japanese dictionary A in FIG. 2.

The first input unit 121 and the second input unit 122 receive an input of information regarding an operation (working) of the electronic dictionary 1. The input received by the first input unit 121 and the second input unit 122 includes an input for selecting the content and an input of the entry word or the like. The display 130 visualizes and displays information regarding the working and the like of the electronic dictionary 1. The information displayed by the display 130 includes information on a content selection screen, information on an entry word input screen, information on a screen of the search result of the entry word, detailed information on the entry word, and the like. A function of the first input unit 121 is provided by, for example, the keyboard 2 (see FIG. 1). Functions of the second input unit 122 and the display 130 are provided by the touch panel display 4 (see FIG. 1). The second input unit 122 is an optional function (constitutional element) of the electronic dictionary 1 and may be omitted.

The sound collection unit 140 converts sound (sound wave) of the surroundings of the electronic dictionary 1 into voice data (electric signal). The sound emission unit 150 emits sound data (electric signal) as sound (sound wave) to the surroundings of the electronic dictionary 1. In the electronic dictionary 1, one or both of the sound collection unit 140 and the sound emission unit 150 may be omitted.

Next, the dictionary data 7, the priority information 8, and the threshold information 9 included in the content will be described.

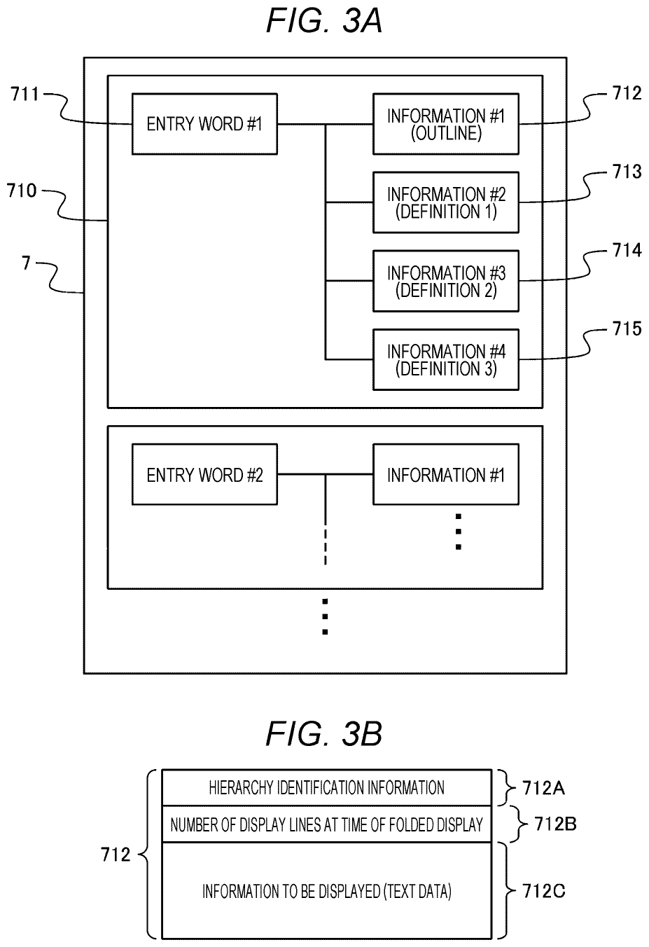

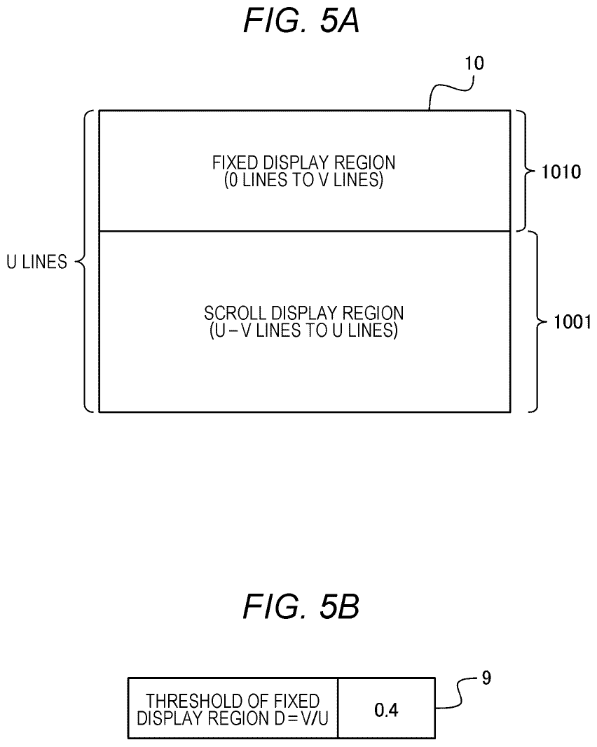

The dictionary data 7 has, for every entry word, a hierarchical structure of an entry word and detailed information on the entry word. For example, in the dictionary data 7 illustrated in FIG. 3A, first hierarchical structure information 710 for a first entry word (entry word #1) includes a root element 711 in the first hierarchy indicating the first entry word, and text elements 712 to 715 in the second hierarchy having a parent-child relationship with the root element 711. In a case where the first entry word, which is the root element 711, is an English word, the text element 712 includes, for example, text data of an outline (for example, information such as phonetic symbols, typical Japanese translations among Japanese translations, and word origins) for the first entry word. The text elements 713 to 715 includes, for example, text data in which a Japanese translation of the first entry word, an example sentence, and the like are described for every meaning of a word. The text elements 712 to 715 in the electronic dictionary 1 according to the present embodiment includes, for example, as in the text element 712 illustrated in FIG. 3B, hierarchy identification information 712A that identifies the text element 712, a number of display lines 712B at the time of folded display, and information (text data) 712C to be displayed. The hierarchy identification information 712A includes, for example, information indicating that the information is included in the second hierarchy under the root element 711 and information indicating the display order at the time when the text data of the text elements 712 to 715 is displayed. The number of display lines 712B at the time of the folded display is the number of display lines of when text data of the text element 712 is abbreviated and displayed in a fixed display region (see FIG. 5A) of the display screen. The number of text elements in the second hierarchy in one hierarchical structure information is not limited to four. Furthermore, the hierarchical structure information may include a text element in the third hierarchy under the text element in the second hierarchy. The element under the root element in the hierarchical structure information is not limited to the text element, and may include an element including text data and image data. The term “abbreviated display” in the present specification is intended to display a part of text data being a target of display in the fixed display region, or a keyword, a summary, or the like associated with the content of the text data in an allocated partial region in the fixed display region.

The description format of the information in the dictionary data 7 including the first hierarchical structure information 710 is not limited to a specific format. The information in the dictionary data 7 may be described, for example, in accordance with a description format of extensible markup language (XML).

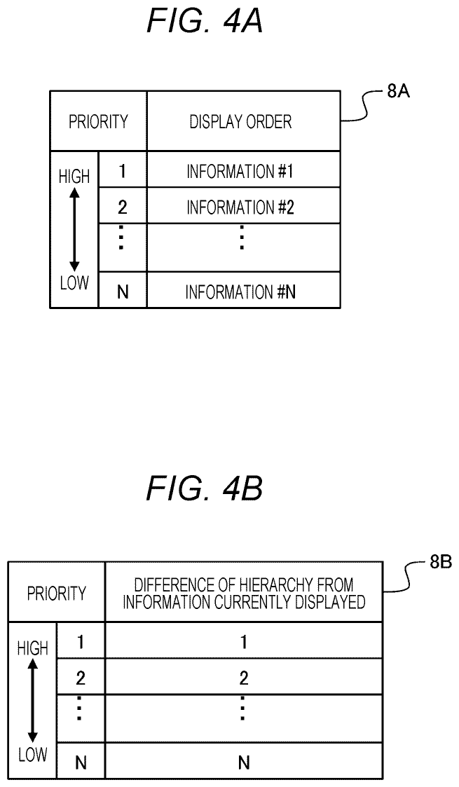

The priority information 8 can be information indicating priority of when text data of a plurality of text elements is selectively displayed in a fixed display region of the display screen. In priority information 8A illustrated in FIG. 4A, the priority follows the display order of the text data to be displayed on the display 130, and the text element including the text data with an earlier display order has a higher priority. The display order of the text data of the text elements 712 to 715 illustrated in FIG. 3A is based on the information indicating the display order included in the hierarchy identification information of each text element. For example, the text data of the text element 712 is first displayed, and when an operation of scrolling in a predetermined direction (for example, a downward scroll operation of displaying a text below the displayed text in the text data) is performed, the text data of the text element 713, the text data of the text element 714, and the text data of the text element 715 are displayed in this order. In this case, according to the priority information 8A, the text element 712 has the highest priority, and the text element 713, the text element 714, and the text element 715 have lower priority in this order. Note that the display order of the priority information 8A in FIG. 4A may also serve as information indicating the order of text data displayed in a scroll display region 1001 when an operation of scrolling in a predetermined direction is performed.

The priority information 8B illustrated in FIG. 4B follows the order of the difference in the hierarchy from the text element including the text data currently displayed (at the time of determining the priority), and the text element having a smaller difference has a higher priority. According to the priority information 8B, at the time when the text data of the text element 714 among the text elements 712 to 715 illustrated in FIG. 3A is displayed, the priority of the text element 713 is higher than that of the text element 712.

The threshold information 9 can be an upper limit value of the fixed display region set in the display screen, and can be, for example, a value of V in the line 0 to the line V in FIG. 5A. In the electronic dictionary 1 of the present embodiment, at the time when the text data of the plurality of text elements included in one piece of hierarchical structure information is displayed on the display 130, as illustrated in FIG. 5A, the display screen 10 can be vertically divided into two, the lower side can be a scroll display region 1001, and the upper side can be a fixed display region 1010. The scroll display region 1001 is a region in which a range of a text to be displayed on the display 130 can be changed in accordance with the scroll operation. The fixed display region 1010 is a region for displaying a text of a text element different from the text element including the text displayed in the scroll display region 1001 among the text (in other words, the text displayed in the scroll display region 1001 at the time when the user scrolls up) above the text displayed in the scroll display region 1001. That is, the scroll display region 1001 is a scrollable region, and the fixed display region 1010 is a non-scrollable region.

In the electronic dictionary 1 of the present embodiment, a ratio between the scroll display region 1001 and the fixed display region 1010 in the display screen 10 changes in accordance with the user operation. As illustrated in FIG. 5A, in a case where the display screen 10 can display U lines of text among all the text, the fixed display region 1010 is variable in a range of 0 lines to V (<U) lines, and the number of lines of the scroll display region 1001 is changed in accordance with the number of lines of the fixed display region 1010 in the display screen 10. Note that the number of display lines of the text in the display screen 10 changes, for example, in accordance with the size of the characters. Therefore, the upper limit value (threshold) of the fixed display region in the threshold information 9 may be, for example, a value D obtained by dividing the maximum number of lines V of the fixed display region 1010 by the number of display lines U in the display screen 10 as illustrated in FIG. 5B. In a case where U=10 and D=0.4, the fixed display region 1010 is variable in a range of 0 to 4 lines.

Note that, in the electronic dictionary 1 of the present embodiment, switching may be enabled between a working mode in which a ratio between the scroll display region 1001 and the fixed display region 1010 can be changed in accordance with the scroll operation and a working mode in which the entire display screen 10 is always set as the scroll display region 1001.

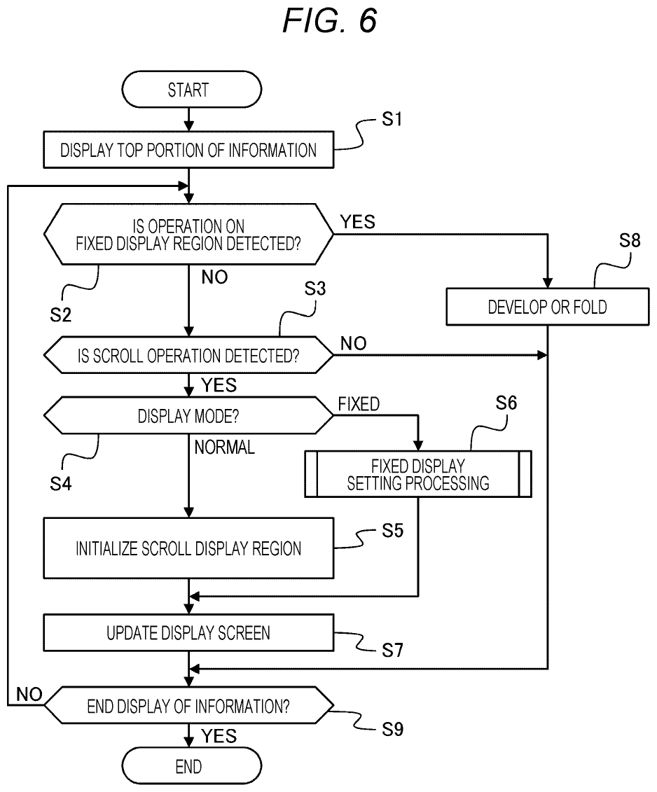

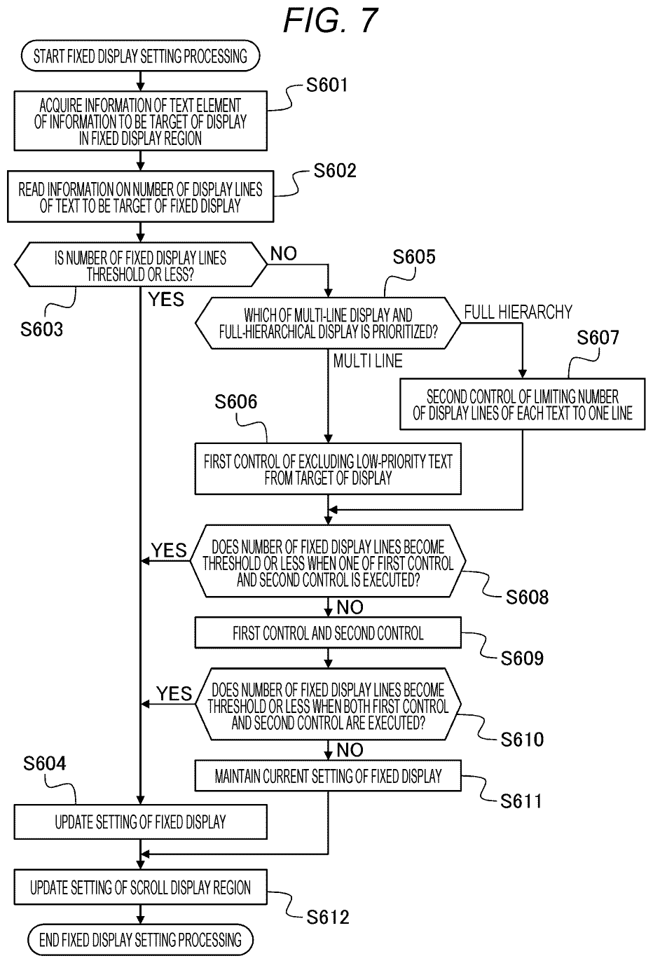

Next, an example of display control of the text data in the electronic dictionary 1 of the present embodiment will be described with reference to FIGS. 6 and 7. In a case where detailed information on a certain entry word is designated as information of the hierarchical structure to be displayed by a known user operation, the electronic dictionary 1 performs, for example, processing along flowcharts of FIGS. 6 and 7. The processing described below is mainly performed by the processor 100 (for example, a processor that executes a program), and is performed in cooperation with the storage unit 110, the input units 121 and 122, and the display 130.

First, the processor 100 causes the display 130 to display a top portion of text data (detailed information) that is information of the designated hierarchical structure (step S1). In a case where the text elements 712 to 715, which are the detailed information on the entry word of the root element 711 illustrated in FIG. 3A, are designated as the information on the hierarchical structure to be displayed, in step S1, the processor 100 causes the display 130 to display the display screen 10 including, for example, the top (first) text of the text data 712C of the text element 712. At this time, the entire display screen 10 is the scroll display region 1001. In a case where the number of display lines of the text data 712C is less than the number of displayable lines of the scroll display region 1001, a portion of the text data of the text element 713 is displayed following the text data 712C.

Next, the processor 100 determines whether or not an operation on the fixed display region 1010 has been detected by (step S2). The operation on the fixed display region 1010 can be, for example, the operation of pressing a button associated with the information displayed in the fixed display region 1010.

If it is determined that the operation on the fixed display region 1010 has not been detected (step S2; NO), the processor 100 subsequently determines whether or not a scroll operation has been detected (step S3). If it is determined that the scroll operation has not been detected (step S3; NO), the processor 100 subsequently determines whether or not to end the display of the information (step S9). In step S9, the processor 100 determines to end the display of the information in the case of detecting an operation of hiding the entire information of the hierarchical structure currently displayed, for example, an operation of searching for another entry word, an operation of executing another content, or the like. If it is determined not to end the processing (step S9; NO), the processor 100 performs the determination in step S2.

If it is determined that the scroll operation has been detected (step S3; YES), the processor 100 determines whether the current display mode is “Normal” or “Fixed” (step S4). “Normal” is a display mode in which the fixed display region 1010 is not always displayed regardless of the range of the text displayed on the display screen 10, and “Fixed” is a display mode in which the fixed display region 1010 corresponding to the range of the text displayed on the display screen 10 is set. If it is determined that the display mode is “Normal” (step S4; NORMAL), the processor 100 initializes the scroll display region 1001 of the display screen 10 (step S5). In step S5, the processor 100 sets the entire display screen 10 to the scroll display region 1001. If it is determined that the display mode is “Fixed” (step S4: FIXED), the processor 100 performs fixed display setting processing (step S6). In step S6, the processor 100 sets the scroll display region 1001 and the fixed display region 1010 in the display screen 10, and performs setting of the display in the fixed display region 1010. After the processing of step S5 or step S6, the processor 100 updates the display screen 10 on the basis of the processing result of step S5 or step S6 and the scroll amount corresponding to the detected scroll operation (step S7). After step S7, the determination in step S9 described above is performed. If it is determined not to end the processing (step S9; NO), the processor 100 performs the determination in step S2.

On the other hand, if it is determined in step S2 that the operation on the fixed display region 1010 has been detected (step S2; YES), the processor 100 unfolds or folds the information displayed in the fixed display region 1010 in accordance with the detected operation (step S8). A specific example of step S8 will be described later. After step S8, the processor 100 performs the determination in step S9 described above. If it is determined not to end the processing (step S8; NO), the processor 100 performs the determination in step S2. The processing in step S8 may be incorporated into the fixed display setting processing in step S6.

The fixed display setting processing in step S6 includes, for example, processing in steps S601 to S612 illustrated in FIG. 7. A program for causing the electronic dictionary 1 to execute the fixed display setting processing may be incorporated as a part of a main routine or may be incorporated as a subroutine in a display control program corresponding to the flowchart in FIG. 6.

In step S601, the processor 100 acquires information of the text element including information (text) to be the target of display in the fixed display region 1010 of the display screen 10 specified in accordance with the detected scroll operation. If the operation of scrolling down is detected, in step S601, the processor 100 acquires information of a text element including information (text) already displayed in the fixed display region 1010 and information of a text element including information (text) that can be newly displayed in the fixed display region 1010. If the operation of scrolling up is detected, in step S601, the processor 100 identifies a text element including a text displayed in the uppermost line of the scroll display region 1001 at the time when the range of the text to be displayed in the scroll display region 1001 of the display screen 10 is changed in accordance with the detected scroll operation, and acquires information on a text element including a text displayed further on the top side than the text of the above-described text element.

Next, the processor 100 derives the number of display lines of information (text) to be the target of display in the fixed display region 1010 (step S602), and determines whether or not the derived number of display lines is equal to or less than a threshold (step S603). In step S602, the processor 100 calculates the sum of the number of display lines at the time of folded display of the text element specified as the target of display in the fixed display region 1010 in step S601 among all the texts on the basis of the information of the text element acquired in step S601. In step S603, the processor 100 determines whether or not a value obtained by dividing the number of display lines derived in step S602 by the number of display lines U of the display screen 10 is equal to or less than a threshold D of the threshold information 9 (see FIG. 5B). If it is determined that the number of display lines is equal to or less than the threshold (step S603; YES), the processor 100 updates the setting of the fixed display (step S604). The setting of the fixed display includes setting of the range (the number of lines) of the fixed display region 1010 in the display screen 10, the number of display lines of the text for every text element to be displayed in the fixed display region 1010, and the range of the text to be displayed.

If it is determined that the number of display lines is larger than the threshold (step S603; NO), the processor 100 then determines which one of multi-line display and full-hierarchical display is prioritized (step S605). The “multi-line display” is intended to display the text of the text element in the number of display lines at the time of folded display, and the “full-hierarchical display” is intended to display the text of all the text elements specified in step S601 as the target of display in the fixed display region 1010. Which one of the multi-line display and the full-hierarchical display is prioritized may be switchable by a predetermined user operation. If it is determined that the multi-line display is prioritized (step S605; MULTI LINE), the processor 100 temporarily executes the first control of excluding the text element with low priority to be displayed in the fixed display region 1010 from the display target in the fixed display region 1010 on the basis of the priority information 8 (step S606). If it is determined that the full-hierarchical display is prioritized (step S605; FULL HIERARCHY), the processor 100 temporarily executes the second control to set the number of display lines of the text of all the text elements to be displayed in the fixed display region 1010 to one line (step S607). After step S606 or S607, the processor 100 determines whether or not the number of display lines in the fixed display region 1010 becomes equal to or less than the threshold in a case where one of the first control and the second control is temporarily executed (step S608). The above “first” and “second” are intended only to distinguish between the two controls, and are not intended that the first control in step S606 precedes (prioritizes) the second control in step S607. That is, the control in step S607 may be referred to as the “first control”, and the control in step S606 may be referred to as the “second control”.

If the number of display lines is equal to or smaller than the threshold as a result of temporarily executing the first control in step S606 (step S608; YES), the processor 100 fully executes the first control of updating the setting of the fixed display on the basis of the text element to be displayed in the fixed display region 1010 excluding the text element excluded in step S606, and updates the setting of the fixed display (step S604). If the number of display lines is equal to or smaller than the threshold as a result of temporarily executing the second control in step S607 (step S608; YES), the processor 100 fully executes the second control of setting the number of display lines of the text of all the text elements to be displayed in the fixed display region 1010 to one line, and updates the setting of the fixed display (step S604).

If it is determined that the number of display lines is larger than the threshold even after step S606 or step S607 is performed (step S608; NO), the processor 100 temporarily executes both the first control and the second control (step S609), and determines whether or not the number of display lines in the fixed display region 1010 becomes equal to or less than the threshold in a case where both the first control and the second control are temporarily executed (step S610). Step S609 can be, for example, processing of limiting the number of display lines of the text of all the text elements to one line, the text elements remaining as the display target in the fixed display region 1010 by the processing of step S606. Step S609 may be, for example, processing of further excluding a text element with low priority among all the text elements remaining as the display target by the processing in step S606, and thereafter, setting the number of display lines of the text of the text element remaining as the display target to one line.

If the number of display lines is equal to or smaller than the threshold as a result of performing step S609 (step S610; YES), the processor 100 updates the setting of the fixed display such that the number of display lines of the text of all the text elements remaining as the display target in the fixed display region 1010 is set to one line (step S604). If it is determined that the number of display lines is larger than the threshold even after performing step S609 (step S610; NO), the processor 100 maintains the current fixed display setting (step S611). The current fixed display setting is the setting of the fixed display at the time when the currently performed fixed display setting processing is started (in other words, the setting of the fixed display immediately before the detection of the scroll operation that triggers the start of the currently performed fixed display setting processing). After step S604 or step S611, the processor 100 updates the setting of the scroll display region 1001 on the basis of the setting of the fixed display (step S612), and ends the fixed display setting processing. Note that, if the information of the text element acquired in step S601 is not changed before and after the detected scroll operation (in other words, in a case where the text displayed in the scroll display region 1001 before and after the scrolling is the text of the same text element), the processing in step S602 and subsequent steps may be omitted.

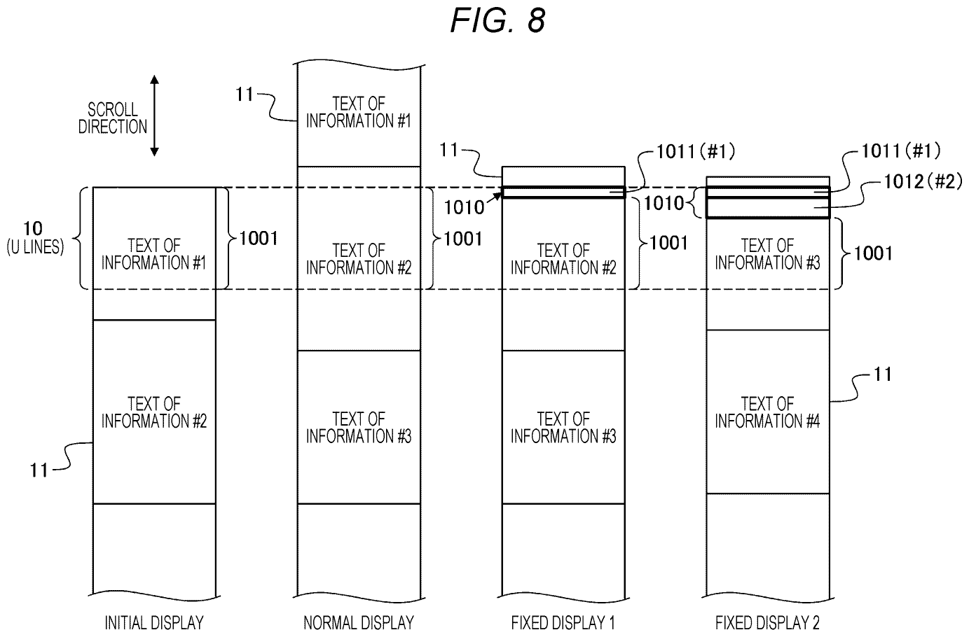

A specific example of the display control processing described above with reference to FIGS. 6 and 7 will be described below. In step S1, for example, as in “INITIAL DISPLAY” in FIG. 8, the entire display screen 10 having U lines is the scroll display region 1001, and the text of the first (top) U lines of text data 11 in which the texts of the plurality of text elements are connected is displayed in the scroll display region 1001. In the text data 11 in FIG. 8, the upper side is the top side, and the lower side is the end side. Information #1, information #2, information #3, and information #4 in the text data 11 represent blocks corresponding to the text data of the text elements 712 to 715 in FIG. 3A. In the text data 11 being initially displayed, a range to be displayed in the scroll display region 1001 can be changed by the scroll operation of scrolling down. In a case where the display mode of the electronic dictionary 1 is “Normal”, even when the text displayed in the scroll display region 1001 is changed to the text of the information #2 by the scroll operation of scrolling down, the entire display screen 10 having U lines remains in the scroll display region 1001 as in “NORMAL DISPLAY” in FIG. 8. The display screen 10 of the display 130 (touch panel display 4) of the electronic dictionary 1 has a diagonal size of about several tens of centimeters, and there is a limit to information (text) that can be displayed in the display screen 10 at a time. In the case of the normal display, because the entire display screen 10 of the display 130 is set as the scroll display region 1001, the browsability of the text of one text element is high, but it may be difficult to grasp the content of the text of the text element on the upper side (top side) of the text element of the currently displayed text.

In the electronic dictionary 1 according to the present embodiment, as described above, by fixedly displaying the display mode, the fixed display region 1010 can be set variable in the range of 0 lines to V (<U) lines in the display screen 10 having U lines. In the fixed display region 1010, it is possible to perform the abbreviated display in which the text of the text element further on the top side of the text data 11 than the text element including the text displayed in the scroll display region 1001 is folded within a range of one line to several lines. Therefore, for example, when the text of the information #2 is displayed in the scroll display region 1001 as in “FIXED DISPLAY 1” in FIG. 8, only the topmost line of the display screen 10 having U lines is set as the fixed display region 1010, and the remaining U-1 lines become the scroll display region 1001. At this time, a text 1011 (#1) obtained by folding the text of the information #1 into one line is displayed in the fixed display region 1010. When the scroll operation is performed in such a display state, the display in the scroll display region 1001 is changed in accordance with the scroll operation, but the display of the folded text 1011 (190 1) in the fixed display region 1010 is not changed.

Further, when the information #3 is displayed in the scroll display region 1001 as in “FIXED DISPLAY 2” in FIG. 8, for example, the text 1011 (#1) obtained by folding the text of the information #1 is displayed in the topmost line of the display screen 10 having U lines, and a text 1012 (#2) obtained by folding the text of the information #2 into two lines is displayed in two lines which are the second and third lines from the top. That is, in “FIXED DISPLAY 2” in FIG. 8, three rows from the top of the display screen 10 having U lines become the fixed display region 1010, and the remaining U-3 lines become the scroll display region 1001. Note that, in “FIXED DISPLAY 2” in FIG. 8, the folded text 1012 (#2) of the information #2 is set to have two lines, but the number of lines at the time of the abbreviated display may be one line or three lines. In a case where the upper side of the text data 11 is the top side and the lower side is the end side, the text that has been moved to the upper part of the display screen 10 by the downward scrolling and hidden is displayed by the abbreviated display in the fixed display region 1010 set in the upper part of the display screen 10, so that the user can easily understand that the information displayed in the fixed display region 1010 is information above the information displayed in the scroll display region 1001. Note that the position of the fixed display region 1010 on the display screen 10 is not limited to the upper part of the scroll display region 1001. For example, in a case where the information displayed in the scroll display region 1001 is scrolled up to move to the lower part of the screen, the fixed display region 1010 may be set below the scroll display region 1001. The text of each block in the text data 11 may be aligned in a display order assumed to be browsed while being scrolled up. For example, in text data 11 illustrated in FIG. 8, the lower side may be the top side and the upper side may be the end side, and in this case, the fixed display region 1010 is set below the scroll display region 1001.

Although the detailed description is omitted, in the display state of the fixed display 2 in FIG. 8, by changing the display in the scroll display region 1001 from the text of the information #3 to the text of the information #2 by the upward scrolling, the display of the display 130 is changed from the display state of the fixed display 2 to the display state of the fixed display 1. In the display state of the fixed display 1 in FIG. 8, by changing the display in the scroll display region 1001 from the text of the information #2 to the text of the information #1 by the upward scrolling, the display of the display 130 is changed from the display state of the fixed display 1 to the display state of the initial display. Further, in the display state of the fixed display 1, by performing the operation of changing the display mode from the fixed display to the normal display, the display of the display 130 is changed from the display state of the fixed display 1 to the display state of the normal display. On the other hand, in the display state of the normal display in FIG. 8, by performing the operation of changing the display mode from the normal to the fixed, the display of the display 130 is changed from the display state of the normal display to the display state of the fixed display 1.

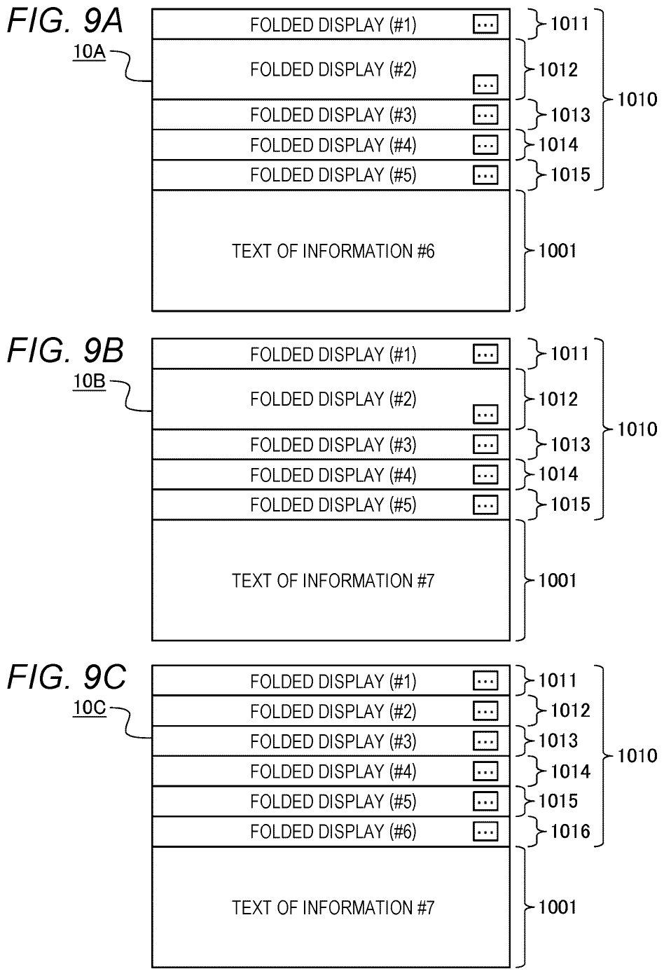

As described above, in the electronic dictionary 1 according to the present embodiment, the ratio of the fixed display region 1010 in the entire display screen 10 is variable, and the text to be displayed in the fixed display region 1010 is folded in the range of one line to several lines. In addition, in the electronic dictionary 1 according to the present embodiment, an upper limit is set on the ratio of the fixed display region 1010 in the entire display screen 10 by the threshold information 9. For example, even when the ratio of the fixed display region 1010 in a display screen 10A illustrated in FIG. 9A reaches the upper limit, the electronic dictionary 1 that has detected the scroll operation of scrolling down performs the fixed display setting processing illustrated in FIG. 7. When the text to be displayed in the scroll display region 1001 is changed from the text of information #6 to the text of information #7 after the detected scroll operation, the number of text elements to be displayed in the fixed display region 1010 is increased by one. Therefore, when the text of all the target text elements is made to display in the fixed display region 1010, the number of fixed display lines is increased by one or more lines as compared with that before the scroll operation. Therefore, the electronic dictionary 1 determines that the number of fixed display lines is larger than the threshold in step S603, and performs the temporary execution of the first control in step S606 or the temporary execution of the second control in step S607 through the determination in step S605.

In step S606 performed in a case where the multi-line display is prioritized, the electronic dictionary 1 temporarily executes, for example, the first control of excluding the text having the lowest priority to be displayed in the fixed display region 1010 from the display target in the fixed display region 1010 from among the six texts, the information #1 to the information #6, on the basis of the priority information 8. In a case where the priority information 8 is the priority information 8A of the display order illustrated in FIG. 4A, the text of the information #6 having the lowest priority is excluded from the display target in the fixed display region 1010. As a result of step S606, the text to be displayed in the fixed display region 1010 remains five texts from the folded text 1011 of the information #1 to the folded text 1015 of the information #5 in the display screen 10A in FIG. 9A, and the number of display lines of each of the texts 1011 to 1015 folded and displayed does not change. Therefore, in step S608 subsequent to step S606, the electronic dictionary 1 determines that the number of the fixed display lines becomes equal to or less than the threshold when the first control is executed, and fully executes the first control to update the fixed display setting (step S604). Note that, in this example, because the text to be displayed in the fixed display region 1010 does not change, the update of the setting of the fixed display in step S604 is the update of overwriting in which the setting information does not change before and after step S604. That is, in a case where the display in the scroll display region 1001 is changed from the text of the information #6 to the text of the information #7 by the scroll operation, the screen displayed on the display 130 through the processing of step S606 is changed from the display screen 10A illustrated in FIG. 9A to a display screen 10B illustrated in FIG. 9B.

In step S607 performed in a case where the full-hierarchical display is prioritized, the electronic dictionary 1 temporarily executes the second control of setting the number of display lines of the six texts 1011 to 1016 of the information #1 to the information #6 to one line as in a display screen 10C illustrated in FIG. 9C. On the display screen 10C, the folded text 1016 of the information #6 can be displayed by an amount obtained by reducing the number of display lines of the folded text 1012 of the information #2, the number of display lines of which is larger than the number of display lines of other folded texts, to one line on the display screen 10A. Therefore, in step S608 subsequent to step S607, the electronic dictionary 1 determines that the number of the fixed display lines becomes equal to or less than the threshold when the second control is executed, and fully executes the second control to update the fixed display setting (step S604). In this example, the setting of the fixed display is updated to the setting indicating that all the texts 1011 to 1016 of the information #1 to the information #6 are folded into one line and displayed.

Although the detailed description is omitted, when a scroll operation of scrolling up is performed while the display screen 10B or the display screen 10C is displayed, and the display of the scroll display region 1001 is changed from the text of the information #7 to the text of the information #6, the display of the display 130 is changed from the display screen 10B or the display screen 10C to the display screen 10A. Further, for example, when the scroll operation of scrolling down is performed while the display screen 10C is displayed and the display in the scroll display region 1001 is changed from the text of the information #7 to the text of the information #8, the electronic dictionary 1 maintains the current fixed display setting (step S611). In a case where the priority information 8 is the priority information 8B illustrated in FIG. 4B, when the text of the information #8 is displayed in the scroll display region 1001, for example, the folded texts of the information #2 to #7 are displayed in the fixed display region 1010.

As described above, when the user operation of scrolling the text (information) displayed in the scroll display region 1001 is detected, the electronic dictionary 1 according to the present embodiment changes the ratio between the scroll display region 1001 and the fixed display region 1010 in the display screen 10 in accordance with the user operation. In other words, the electronic dictionary 1 can change the amount of displayable information in the scroll display region 1001 and the amount of displayable information in the fixed display region 1010 in accordance with the scroll operation. Therefore, the electronic dictionary 1 according to the present embodiment can suppress a decrease in information browsability due to a decrease in the ratio of the scroll display region 1001 as compared with the electronic dictionary of JP 2013-186753 A in which the ratio of the fixed display region in the display screen is fixed. Note that, in the present specification, an example in which a text is folded (only information of first one line to several lines of the text is displayed) has been described as an example of the abbreviated display of the fixed display region 1010, but the display form at the time of the abbreviated display is not limited thereto. The display form at the time of the abbreviated display in the fixed display region 1010 may be, for example, a form in which it is easy to intuitively understand what kind of information the text includes, such as displaying a keyword extracted from the text that is a target of the abbreviated display.

Further, in the electronic dictionary 1 of the present embodiment, the proportion of the scroll display region 1001 decreases as the amount of scroll from the display state corresponding to the initial display in FIG. 8 increases. However, by setting the upper limit (threshold) to the proportion of the fixed display region 1010, more pieces of information can be displayed on the display screen 10 while decrease in the browsability of information displayed in the scroll display region 1001 is suppressed. Furthermore, by reducing the number of texts (text elements) to be displayed in the fixed display region 1010 or the number of display lines at the time of the folded display of each text on the basis of the priority information 8 such that the ratio of the fixed display region 1010 does not exceed the upper limit, deterioration of operability can be suppressed. In particular, by reducing the number of display lines at the time of the folded display of each text, texts of more text elements can be displayed in the fixed display region 1010, and the decrease in the browsability of information is also suppressed. In addition, in a case where the number of texts (text elements) to be displayed in the fixed display region 1010 is reduced on the basis of the priority information 8, because a text of a text element close to the text (text element) to be displayed in the scroll display region 1001 in accordance with the scroll operation remains in the fixed display region 1010, the relationship between the text to be displayed in the scroll display region 1001 and the text to be displayed in the fixed display region 1010 becomes easily grasped.

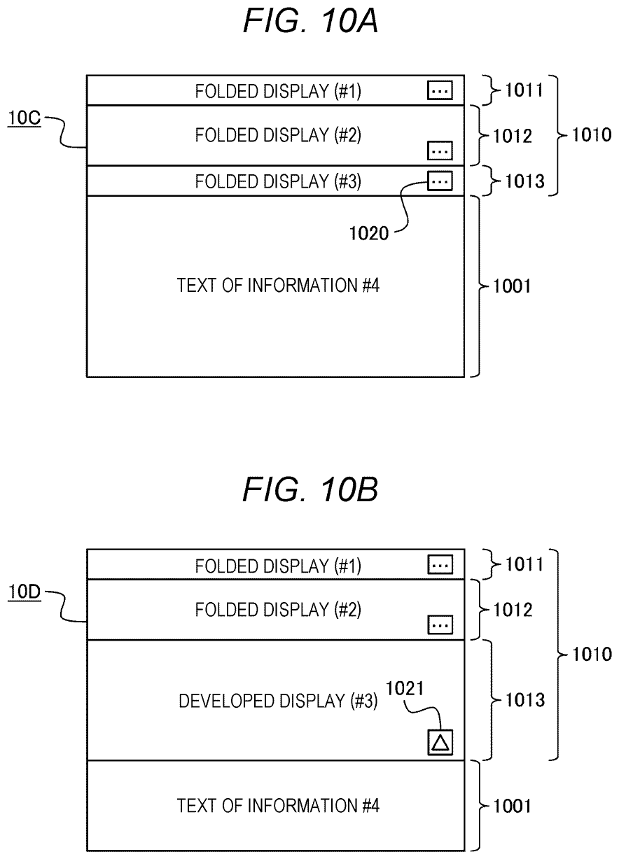

Furthermore, as described above with reference to FIG. 6, the electronic dictionary 1 according to the present embodiment may be able to unfold text data that is folded and displayed in the fixed display region 1010. For example, FIG. 10A illustrates a display screen 10C in which the three texts 1011 to 1013 of the information #1 to the information #3 are folded and displayed in the fixed display region 1010. Operation buttons 1020 are displayed in association with the three texts 1011 to 1013 displayed in the fixed display region 1010. When the operation button 1020 associated with the folded text 1013 of the information #3 is pressed while the display screen 10C is being displayed, the electronic dictionary 1 determines that the operation on the fixed display region 1010 has been detected (step S2; YES). At this time, the electronic dictionary 1 changes the text 1013 of the information #3 from the folded display to the unfolded display (step S3) as in a display screen 10D illustrated in FIG. 10B, and displays an operation button 1021 for returning to the folded display. Upon detecting the operation of pressing the operation button 1021, the electronic dictionary 1 causes the display 130 to display the display screen 10C in which the text 1013 of the information #3 is changed from the unfolded display to the folded display.

As described above, by temporarily unfolding and displaying the text folded and displayed in the fixed display region 1010, it becomes possible to save the trouble of performing the scroll operation on the scroll display region 1001, and the operability of the electronic dictionary 1 is improved. Note that, in a case where the information to be displayed in the fixed display region 1010 includes a portion that cannot fit in the display screen 10, the information displayed in the fixed display region 1010 in the unfolded state may be made temporarily scrollable.

The embodiments described above are specific examples to facilitate understanding of the present disclosure, and the present disclosure is not limited to the embodiments described above. The information processing apparatus and the display control method can be variously modified and changed without departing from the scope of the claims. For example, the information processing apparatus according to the present disclosure is not limited to a dedicated electronic device that provides the content of a dictionary such as the electronic dictionary 1 described above, and may be a smartphone, a tablet computer, or a computer in any form that can execute the content of another dictionary. For example, the information processing apparatus may be able to execute the content of the dictionary stored in a server device connected via a communication network such as the Internet by using a web browser. Furthermore, as a program that can cause a computer to execute a function similar to that of the above-described information processing apparatus, the program can be stored and distributed in a recording medium such as a memory card (such as ROM card and RAM card), a magnetic disk (such as flexible disk and hard disk), an optical disk (such as CD-ROM and DVD), or a semiconductor memory. Then, the computer reads the program recorded in the recording medium, and by the operation being controlled by the program, processing similar to the functions described in the embodiment can be realized.

What is claimed is:

1. An information processing apparatus comprising a processor, wherein
in a case of setting a first display region and a second display region on a display screen on which a display displays designated information, the first display region displaying a first portion of the information in a scrollable state and the second display region displaying a second portion of the information different from the first portion in a non-scrollable state,
the processor changes an amount of displayable information in the first display region and an amount of displayable information in the second display region in accordance with a user operation of scrolling display in the first display region.

2. The information processing apparatus according to claim 1, wherein
the second portion of the information is a portion closer to a top side of the information than the first portion of the information, and
the processor moves the information displayed on the top side of the first portion to the second display region and displays the information in accordance with a user operation of scrolling the display of the first display region from the top side to an end side of the information.

3. The information processing apparatus according to claim 2, wherein the processor displays the top side of the information on an upper side of the first display region, and in a state where the end side of the information is displayed on a lower side of the first display region and in a case where display of the first display region is scrolled from the top side toward the end side of the information, the processor sets the second display region as a region on the upper side of the first display region.

4. The information processing apparatus according to claim 2, wherein the processor decreases the amount of displayable information in the first display region and increases the amount of displayable information in the second display region as a scroll amount from a top of the information to the first portion increases.

5. The information processing apparatus according to claim 2, wherein, in a case where the amount of displayable information in the second display region is increased in accordance with a user operation, and in a case where the amount of displayable information after increase exceeds a threshold, the processor changes a display form of the information of the second portion to be displayed in the second display region such that the amount of the information of the second portion to be displayed in the second display region is equal to or less than the threshold.

6. The information processing apparatus according to claim 2, wherein
the information is text data including a plurality of lines of text, and
the processor is configured to: fold text of a plurality of lines within a predetermined range displayed in the second display region among the text data such that a number of lines of the text becomes smaller than a number of lines of the plurality of lines; and
display a folded text subjected to the folding in the second display region.

7. The information processing apparatus according to claim 6, wherein
the plurality of lines of the text of the text data is classified into a plurality of blocks, and
for each of the blocks displayed in the second display region, the processor is configured to:
fold, for every block, text of a plurality of lines such that the number of lines of the text becomes smaller than the number of lines of the plurality of lines; and
display a plurality of folded texts subjected to the folding in the second display region.

8. The information processing apparatus according to claim 7, wherein the processor changes the number of the folded texts to be displayed in the second display region in accordance with the user operation of scrolling display in the first display region.

9. The information processing apparatus according to claim 7, wherein the processor is configured to:
determine whether or not to prioritize display of all blocks to be displayed in the second display region in a case where the amount of displayable information in the second display region is increased in accordance with a user operation and in a case where the amount of displayable information after increase exceeds a threshold;
in a case where it is determined to prioritize the display of all the blocks, perform first control of reducing a display range of text at the time of folding such that the folded texts of all the blocks to be displayed in the second display region are displayed; and
in a case where it is determined not to prioritize the display of all the blocks, perform second control of excluding the folded text of a block having a priority order that is low among all the blocks to be displayed in the second display region from a display target in the second display region.

10. The information processing apparatus according to claim 9, wherein the priority order is higher for a block closer to a block of the text displayed in the first display region.

11. The information processing apparatus according to claim 9, wherein the processor performs both of the first control and the second control in a case where the amount of displayable information exceeds the threshold even when one of the first control and the second control is performed.

12. The information processing apparatus according to claim 10, wherein in a case where the amount of displayable information exceeds the threshold even when both of the first control and the second control are performed, the processor maintains display in the second display region before the user operation is detected.

13. The information processing apparatus according to claim 6, wherein the processor switches the display of the folded text between a state of a folded text and a state of an unfolded text in accordance with a user operation on the folded text.

14. The information processing apparatus according to claim 2, wherein
the processor further performs control to switch between a first display mode in which display of the second display region is enabled and a second display mode in which the display of the second display region is disabled according to a user operation, and
in a case where the display mode is switched to the first display mode while the information is displayed in the second display mode, the processor determines the amount of displayable information in the first display region and the amount of displayable information in the second display region in accordance with a scroll amount from a top of the information to the first portion displayed in the first display region at a time point of the switching.

15. An information processing method executed by a computer of an information processing apparatus, the computer that performs,
in a case of setting a first display region and a second display region on a display screen on which a display displays designated information, the first display region displaying a first portion of the information in a scrollable state and the second display region displaying a second portion of the information different from the first portion in a non-scrollable state,
changing an amount of displayable information in the first display region and an amount of displayable information in the second display region in accordance with a user operation of scrolling display in the first display region.

16. A non-transitory storage medium storing a computer readable program of an information processing apparatus comprising a processor, the program causing the computer to execute processing of,
in a case of setting a first display region and a second display region on a display screen on which a display displays designated information, the first display region displaying a first portion of the information in a scrollable state and the second display region displaying a second portion of the information different from the first portion in a non-scrollable state,
changing an amount of displayable information in the first display region and an amount of displayable information in the second display region in accordance with a user operation of scrolling display in the first display region.
